(19) United States
(12) Patent Application Publication
(10) Pub. No.: US 2006/0112641 A1
(43) Pub. Date: Jun. 1, 2006

(54) Blast-resistant window system

(75) Inventor: Heinrich Salzer, Marburg (DE)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: Salzer Sicherheitstechnik GmbH

(21) Appl. No.: 11/288,543

(22) Filed: Nov. 29, 2005

(30) Foreign Application Priority Data
Nov. 29, 2004 (DE) 102004057470.7-25

(51) Int. Cl. E05C 7/02

(52) U.S. Cl. 49/67

(57) ABSTRACT

A blast-resistant window system for sealing an opening in a wall comprises a window arrangement which seals the opening, and a protective window pane arrangement installed between the window arrangement and an interior space (IR). The window pane arrangement is provided for preventing shards from flying into the interior space (IR) in the event of a blast-induced pressure effect leading to the fragmentation of the window arrangement. A holding device for the protective pane is arranged as a component of the window pane arrangement for connecting a window pane with the wall in such a way that the pane remains swivelable or laterally displaceable relative to the opening especially under normal circumstances, i.e. when no blast-induced pressure wave acts upon the window system.

### INTRODUCTION

The invention relates to a blast-resistant window system for closing an opening in a wall delimiting an inner space, in accordance with the preamble of claim 1.

Such systems are principally known from the state of the art. A protective drape is known from US patent specification U.S. Pat. No. 5,915,449, which drape is made of an elastic woven fabric with a high resistance to tearing and which is mounted behind a window. The protective drape is dimensioned substantially larger with respect to its surface area than the cross section of the window. Any excess fabric of the drape is held in a collecting container at the bottom or on the floor of the windows in superimposed layers of fabric or woven textile. The respective ends of the protective drape are anchored in a fixed manner in the collecting container both above the window as well as at the base of the window. During the occurrence of an explosion-induced blast wave, the window pane is destroyed and the shards of the window pane fly in the direction of an interior space behind the window pane. These shards are intercepted by the protective drape, which will bulge towards the interior space as a result of the influence of the pressure for such a time until the fabric held in reserve in the collecting container is used up and the drape is tensioned at least for a short period in its bulging. The fabric of the protective drape offers a favorable protection against shards and can also be provided in an air-permeable configuration.

The drape is installed in a fixed way behind the window in order to effectively catch flying shards in the event of a blast. This leads to the disadvantage that the window can be accessed only with difficulty from the inside and thus the cleaning of the inside of the window or the opening of the window for airing the room is only possible with difficulty.

A sturdy window system is further known from the European patent application EP 1 035 295 A2. This window comprises a protective device especially in the form of wire cables built into the window frame. In order to prevent a breakthrough of the window pane in the event of a pressure effect caused by a blast, several wire cables are tensioned as close as possible behind the window. These wire cables are preferably provided with an elastic configuration or are held in a resilient manner and therefore allow a deformation or bulging of the window pane in the event of a pressure effect up to a certain degree. They support the window pane in the event of bulging and thus prevent its breakage. The wire cables are tensioned either directly behind the pane in the window frame, or in front of a soffit into which the window frame with the window pane is built. A disassembly or removal of the wire cables is principally not intended because their anchoring must be so stable that they will be able to withstand a blast-induced pressure effect.

When the wire cables are fixed mounted in or in front of the soffit, it is also not possible to open the window to the inside in this case. Moreover, the cleaning of the inner side of the window pane is then also only possible with difficulty, if at all, as a result of the transversally tensioned wire cables.

It is finally known from the state of the art (e.g. from utility model DE 84 17 098 U1) to provide a blast-resistant window system for closing an opening in a wall delimiting an interior space which provides a protective glass arrangement between a window arrangement and the interior space. The protective glass arrangement typically comprises a protective window pane which is preferably embedded in a protective-pane window frame, as well as a holding device for the protective window pane for holding the pane, optionally with the protective-pane window frame in the region of the opening in connection with the wall.

Openings are provided in the frame of the window arrangement situated on the side endangered by an attack, which openings join the space between the window arrangement and the protective glass with ambient environment situated on the side endangered by an attack. Although the pressure arising from an attack with explosives can destroy the window arrangement facing the side endangered by the attack, the maximum pressure is not exerted on the subsequent protective glass because a compression of the air within the space between the two glass units cannot arise to an extent which would endanger the protective window pane as a result of the openings. This window arrangement which is described in the state of the art and faces the side endangered by an attack does not completely seal the opening in the building in an air-tight manner in several variants of the same. As a result it is necessary to provide the protective window pane configuration in such a way that in the closed state it forms an air-tight sealing of the opening in the building. The utility model DE 84 17 098 U1 shows however that the openings arranged in the frame of the window arrangement facing the side endangered by an attack can be sealed by means which will open up outwardly in the case of an occurring pressure which is caused by an explosion for example.

Such a window system can be arranged in such a way that both units (i.e. the window arrangement and the protective window pane) are movably held in a pivoting or rotating fashion. In the closed state of the window arrangement facing the side endangered by an attack, a little fresh air can reach the interior space through the cross section of openings situated in the frame of the window arrangement, as are present in a permanent manner in another embodiment.

This known blast-resistant window system comes with the disadvantage however that for an effective airing of the room it is necessary to open both units, i.e. the window arrangement and the protective window pane. In the opened state of the window system there is no sufficient protection for persons situated in the interior space in the case of an explosion occurring close by.

### OBJECT OF THE INVENTION

Based on this state of the art it is the object of the present invention to further develop a known blast-resistant window system in such a way that the inside of a window arrangement in front of a protective glass arrangement is easily accessible, and further provides an airing function of the window whilst maintaining the protective function.

### SOLUTION

This object is achieved by the subject matter of claim 1. In accordance with the same, the explosion-resistant window system in accordance with the invention is characterized in that a non-sealable permanent airing cross section is present between the protective glass arrangement and the wall.

The window arrangement facing the side endangered by a blast completely seals the opening of a wall, so that the same protects the interior space from air passage in its closed position, which means that the impermeability demanded under energetic and acoustic aspects is given. The protective glass arrangement facing the interior space is used exclusively for the protection against shards or other fragments which would reach the interior space as a result of the breakage of the window arrangement if the protective glass arrangement were not provided. The non-sealable permanent airing cross section between the protective glass arrangement and the wall prevents that maximum pressure acting on the window arrangement during an explosion is transferred to the protective glass arrangement, which is why the same is not destroyed.

The protective glass arrangement in accordance with the invention is especially also suitable for retrofitting existing window arrangements. A strongly improved protection against the blast effects can be achieved with relatively simple means by using typically conventional window arrangements.

The protective glass arrangement merely needs to fulfill the requirements placed on protection against flying shards, and can thus be understood as an “internal protective shield”.

The configuration of the holding frame for the protective glass allows moving away the protective window pane especially under normal circumstances, which can optionally occur in combination with the protective-glass window frame of the opening, so that the inside of the window arrangement or the inside of its window pane is easily accessible. It is especially possible and advisable to leave the window arrangement in an opened position and to leave the protective window pane in its protective position, so that sufficient fresh air is supplied to the interior space through the non-sealable permanent airing cross section and there is simultaneously a protection against attacks for persons situated in the interior space.

Terms such as “usually”, “normal conditions” or “normal state” shall be understood within the scope of the description in such a way that they designate a state or situation during which there is no blast-induced pressure effect in particular on the protective window pane especially and the holding device for the protective pane. Moreover, the term “swiveling” within the scope of the description shall be understood in such a way that it includes the meaning of the words “turning” or “tilting”.

A technically simple configuration of a holding device for the protective pane is possible by fixing the holding device for the protective pane on the wall and outside of the soffit. Special advantages are offered in this connection by the possibility that the protective window pane is larger than the clear cross section of the window opening and covers wall sections adjacent to the soffit with projecting boundary strips. In this case it is necessary that there must be a distance in the horizontal direction between the wall and the protective window pane in order to ensure the permanent airing function. If the available space on the wall in front of the soffit is not sufficiently large enough as a result of furniture or installed elements (e.g. sunscreen devices) for arranging the holding device for the protective window pane, a fixture within the soffit is mandatory.

The holding device for the protective pane comprises in an advantageous embodiment at least two bands and a locking device for releasable joining and arresting of the protective window pane with the wall.

The holding device for the protective pane is advantageously provided with a resilient configuration into the interior space in the case of a blast-induced pressure effect in a direction transversally to the cross-sectional surface of the opening. The resilient configuration of the holding device for the protective window pane comes with the advantage that the same need not be provided with such a strong and expensive configuration and be anchored in the wall than in the case of a non-resilient configuration.

It is advantageous when especially the movement of the protective window pane towards the interior space is subjected to a limitation of its path in the case of a blast-induced pressure effect.

It is finally advantageous when the holding device for the protective pane is configured in the form of a plurality of point-shaped connections which keep the protective window pane, and optionally in combination with the window frame, at a predetermined distance from the wall, so that (apart from the point-shaped connections) at least an air gap remains for airing purposes between the protective window pane or the window frame for the pane and the wall or to the soffit, especially during the normal state.

A minimum distance between outer window arrangement and internal protective glazing of a minimum of 10.0 cm, preferably at least 20.0 cm, allows in the case of an outside casement window that the same can be tilted or turned to an opened positioned when the internal protective glazing is closed. An air exchange can occur between the protective glazing and the wall or its soffit through the lateral airing cross sections or gaps.

Further advantageous embodiments of the holding device for the protective window pane and the window arrangement are the subject matter of the sub-claims.

Seven figures are appended to the description, wherein:

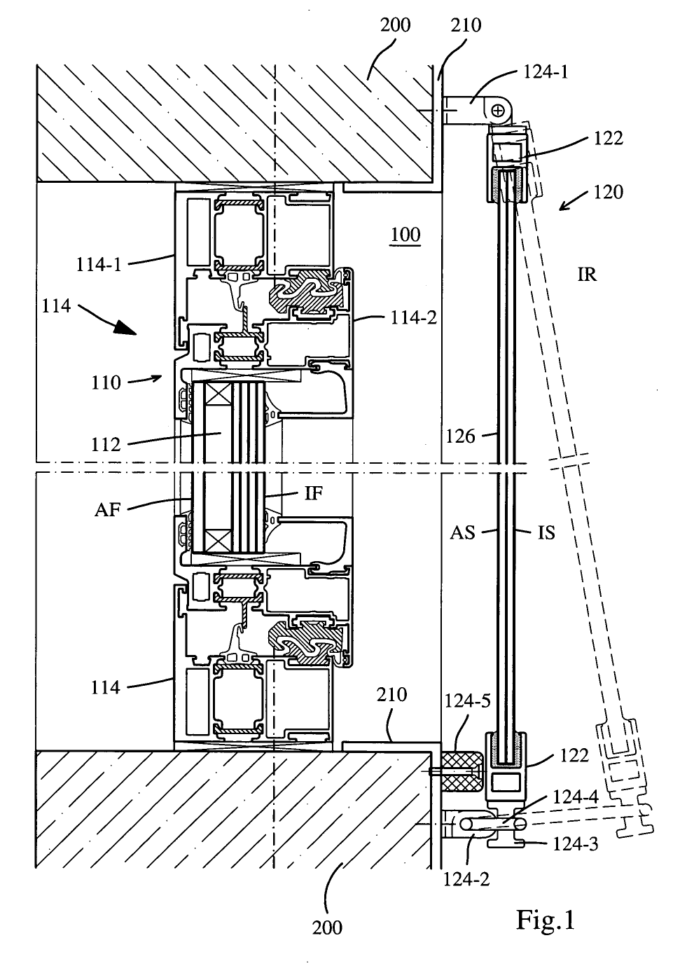

FIG. 1 shows a horizontal sectional view through the window system in accordance with the invention, with the window arrangement being configured as a secure casement window;

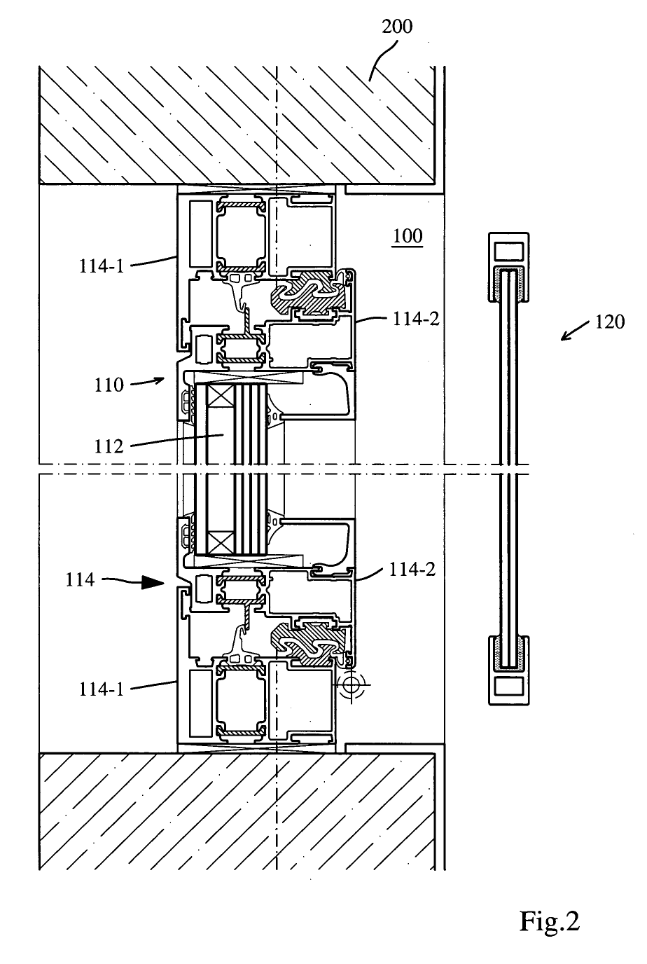

FIG. 2 shows a vertical sectional view through the window system in accordance with the invention according to a first variant;

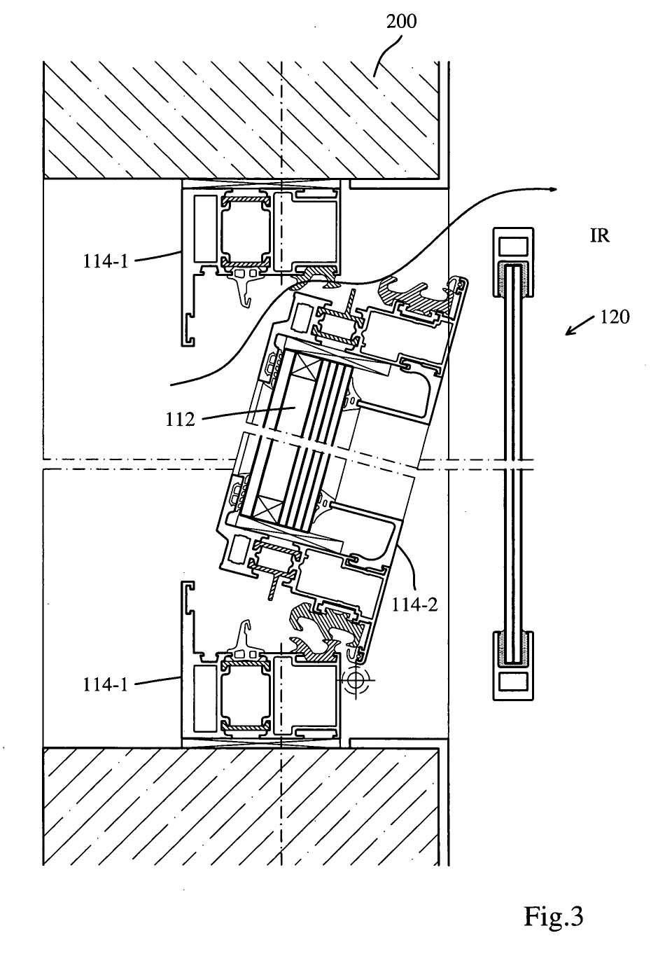

FIG. 3 shows a vertical sectional view through the window system in accordance with the invention according to the first variant with a window arrangement in the tilted position;

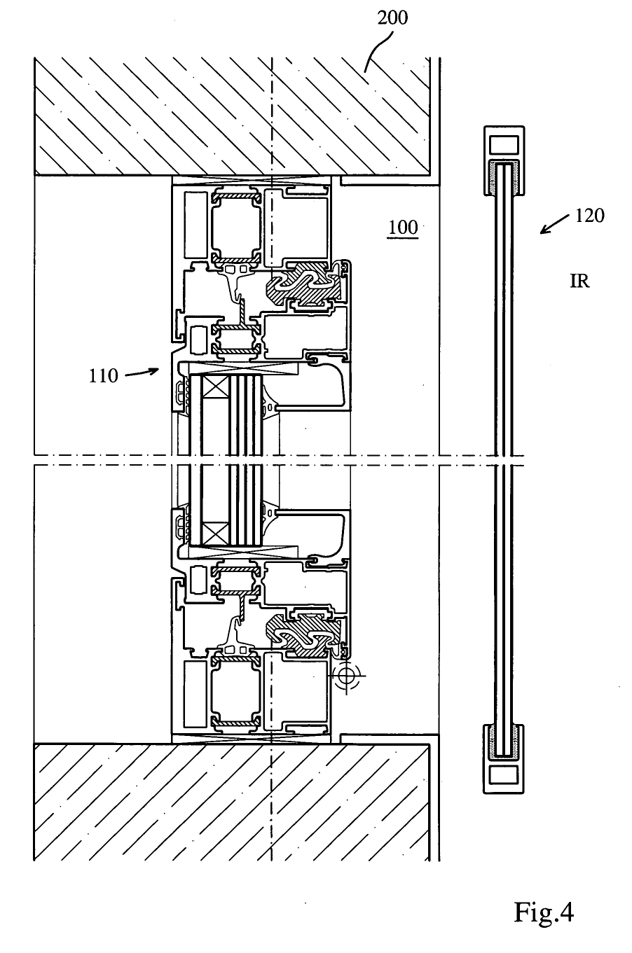

FIG. 4 shows a vertical sectional view through the window system in accordance with the invention according to its second variant;

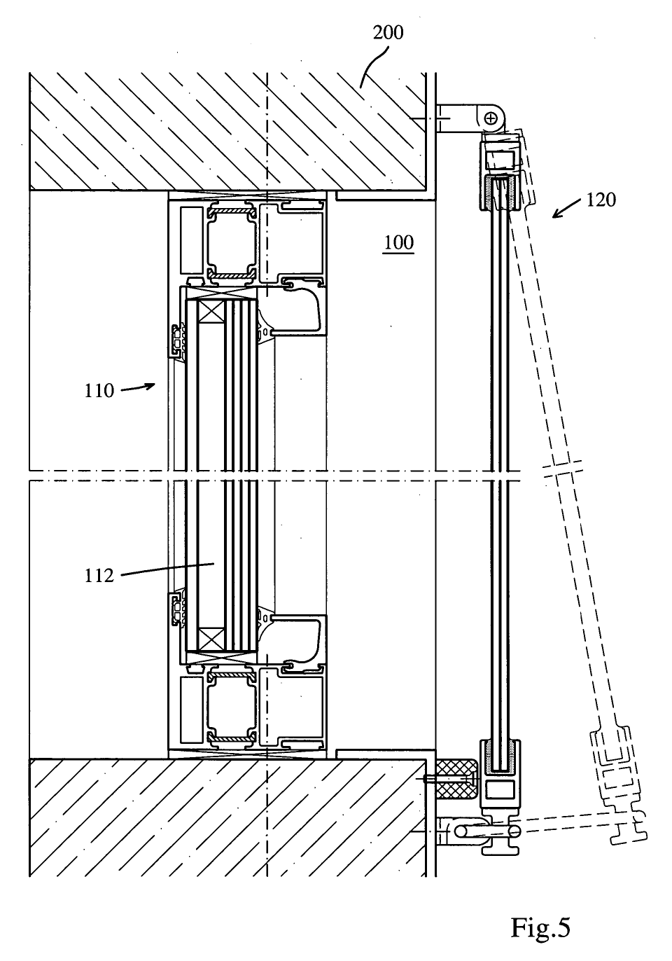

FIG. 5 shows a horizontal sectional view through the window system in accordance with the invention, with the window arrangement being configured as a security fixed field;

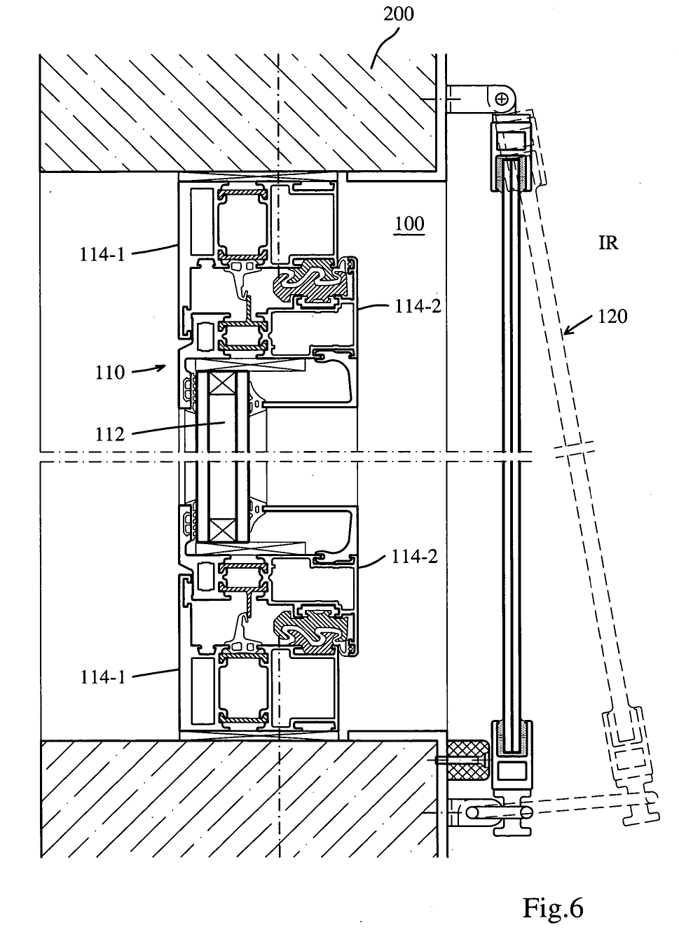

FIG. 6 shows a horizontal sectional view through the window system in accordance with the invention, with the window arrangement being configured as a casement window with a window pane made of a standard Thermopen glazing, and

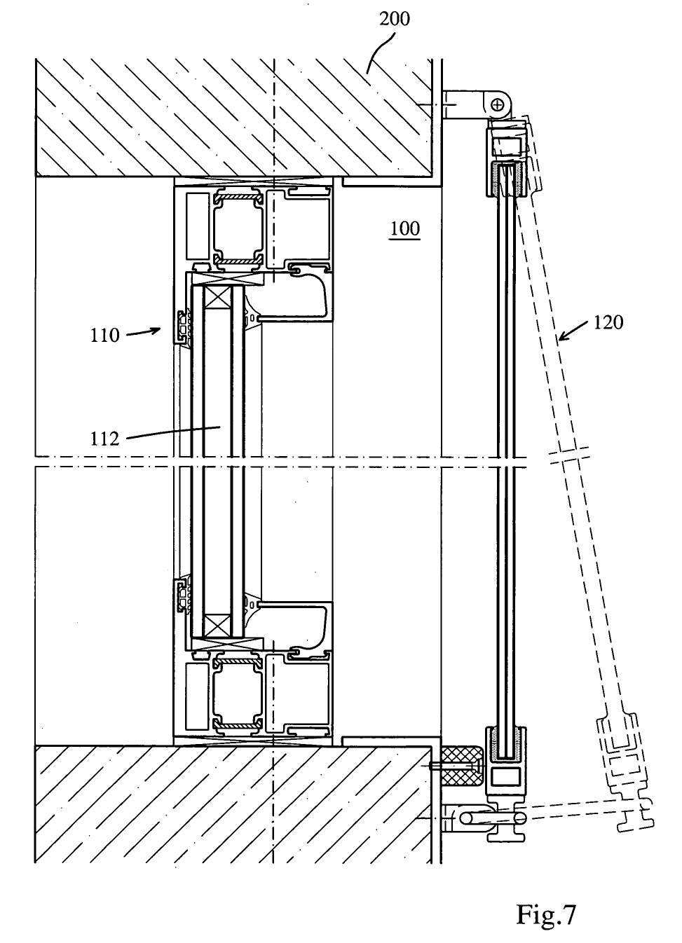

FIG. 7 shows a horizontal sectional view through the window system in accordance with the invention, with the window pane of the window arrangement being configured as a fixed field with a window pane made of standard Thermopen glazing.

The invention is described in detail below in the form of different embodiments by reference to the mentioned figures. The same elements are designated with the same reference numerals in all figures.

FIG. 1 shows a horizontal sectional view through the window system 100 in accordance with the invention. The window system 100 comprises a window arrangement 110 and a protective window pane arrangement 120. The window arrangement 110 is built into an opening of a wall 200 in order to completely seal said opening. The sealing of the opening also seals an interior space IR in a building for example, which interior space is delimited otherwise by the wall 200.

The window arrangement 110 comprises a window pane 112 and a window holding device 114 in form of a window frame for holding the window pane 112 in the opening. The window arrangement 110 is configured as a casement window in which the window pane 112 is embedded in a casement 114-2, which on its part engages in a pivoting manner in a window frame 114-1 joined to the wall 200. The window pane 112 is arranged in the embodiment shown in FIG. 1 as a laminated window pane made of a plurality of individual window panes which are glued together, and it comprises an outside AF averted from the interior space IR and an inside IF facing the interior surface IR.

The said protective window pane arrangement 120 is arranged between the window arrangement 110 and the interior space IR in such a way that it covers the opening at least substantially. The protective window pane arrangement 120 is used to prevent shards or parts of the frame from flying into the interior space IR in the case of a blast-induced fragmentation of the window arrangement for example. It comprises a protective window pane 126, which is typically also a laminated window pane and which is preferably embedded in a window frame 122 for the protective pane. For the purpose of holding or arresting the protective window pane 126, optionally embedded in the window frame 122, the protective window pane arrangement 120 further comprises a holding device 124 for the protective window pane. Said holding device 124 consists of different elements described below which connect the protective window pane or the window frame in a point-like manner either directly or indirectly with the wall 200. An indirect connection would be given when the elements of the holding device 124 would be connected directly with only one frame 210, which on its part is directly connected with the wall 200.

The protective-pane holding device 124 is configured in accordance with the invention in such a way that it allows a lateral displacement (not shown in FIG. 1) or swiveling, which means a turning, tilting or flipping away of the protective window pane 126, which is optionally embedded in the window frame 122, especially in a normal state, which means without any load by a blast-induced pressure wave. The described configuration of the holding device 124 allows a simple access to the inside IF of the window pane 112 and the entire window arrangement 110 for cleaning purposes under normal conditions for example.

Principally, the entire protective window pane arrangement 120 and its anchoring via the holding device 124 in the wall 200 or its soffit must be provided with such a stable configuration that it can withstand a blast-induced pressure wave at least when the pressure wave was considerably weakened previously by a destruction of the window arrangement 110. The holding device 124 comprises concretely for this purpose at least two bands 124-1 or two hinges for pivotably holding the protective window pane 126, optionally in combination with the window frame 122 and a locking device 124-2 . . . -5. The closing device is preferably attached to one side of the window frame opposite of the bands 124-1 and is used for releaseably arresting the protective window pane 126, optionally in combination with the window frame 122 relative to the wall 200. According to FIG. 1, the locking device comprises a first stop 124-2 which is connected with the wall or the frame 210 and to which a spring element 124-4 is fastened. In the normal state, the spring element 124-4 pulls the protective window pane 126 or its frame 122 over a pin 124-3 with a pre-tension against the first stop 124-2, which pin is fastened to the pane or the frame. The spring element 124-4 can be arranged as a rubber ring or a closed wire cable under pre-tension, especially an O-ring. Under normal circumstances it is possible to simply push the rubber ring manually over the pin 124-3, whereupon the protective window pane 126 can be moved away from the opening and the inside of the window arrangement 110 becomes freely accessible.

In the case of the effect of a blast-induced pressure wave for example on the outside AS of the protective window pane 126 which is averted from the interior space IR, the spring element 124-4 offers the advantage that it is provided with a resilient configuration and therefore allows a movement of the window pane 126 in the direction of the pressure wave, which means in the direction of the interior space IR, as indicated in FIG. 1 by the position shown with the broken line of the window pane 126 and the window frame 122. It thus yields to the pressure, which advantageously leads to an only reduced loading of the involved components, especially the holding device for the protective window pane.

As an alternative to the O-ring, the spring element 124-4 can also be arranged as a gas pressure damper or actually as a spring. It is advantageous when the movement of the protective window pane 126 and optionally in combination with the window frame 122 is limited in the case of a blast-induced pressure influence into the interior space IR by a suitable limiting device to a predetermined path length. Scissors or a wire cable loop (not shown in FIG. 1) can be used as a limiting device for example, which in contrast to the spring element 124-4 is not provided with a resilient configuration.

In addition to the elasticity of the locking device, the bands 124-1 can be joined elastically with the wall 200 in such a way that in the case of a pressure burden on the protective window pane arrangement 120 the bands 124-1 can increase their distance to the wall 200 against the effect of an increasing force. An approximately parallel displacement of the protective window pane relative to the window arrangement 110 can be achieved in this manner at an approximately equal spring stiffness in the region of the locking device on the one hand and the bands 124-1 on the other hand. This also provides the possibility of achieving higher pressure equalization cross sections between the wall and the protective window pane.

FIG. 2 shows a vertical sectional view of the same window system 100, of which FIG. 1 shows a horizontal sectional view. FIG. 2 shows a first variant of the protective window arrangement 120 which is characterized in that it does not cover or even overlap the opening in its entire cross section, especially not in its entire height.

FIG. 3 shows the same window system 100 as in FIG. 2, also in a vertical sectional view, but in this case with the casement window not in a closed but tilted position. The meandering arrow in FIG. 3 which is shown in an unbroken line symbolizes an airing duct from the outside of the window arrangement 110 up to and into the interior space IR.

FIG. 4 shows a vertical sectional view through the window system according to FIG. 1, but in this case with a second variant of the protective window arrangement 120. This second variant differs from the first variant shown in FIG. 2 that it is provided with a configuration over a larger surface area and not only covers the opening but even overlaps the same with respect to its surface area. This larger dimensioning of the protective window pane arrangement offers improved protection against shards flying into the interior space IR in the case of a blast.

As a result of the respectively shown vertical sectional view, the FIGS. 2 to 4 do not show the holding device 124 for joining the protective window pane 126 or its frame 122 with the wall 200; the holding device is situated outside of the plane of the drawing.

FIGS. 2 to 4 show however that all variants of the protective window pane arrangement preferably provide an air gap between the air wall 200 and the protective window pane arrangement 120. In order to realize this air gap, the holding device 124 should not be arranged circumferentially around the protective pane 126 or its window frame, but merely in the form of point-like connections as in the form of the band 124-1 or the stop 124-2. The air gap allows an exchange of air between the inside space IR and the outside of the wall or the window arrangement 110 at least when the casement window is opened.

FIG. 5 substantially shows the horizontal sectional view through the window system in accordance with the invention according to FIG. 1, with the only difference that the window arrangement 110 is not arranged in this case as a casement window but as a fixed field, which means a window that cannot be opened. In this case too, the window pane 112 consists of laminated window pane.

FIG. 6 again shows the horizontal sectional view known from FIG. 1 through the window system 100 in accordance with the invention, with the only difference that the window pane 112 of the window arrangement 110 is not arranged as a laminated window pane, but as a normal Thermopen window pane.

Finally, FIG. 7 shows the horizontal sectional view through the window system 100 according to the invention as known from FIG. 1, with the only difference that the window arrangement 110 is configured in this case as a fixed field with a window pane 112 as a normal Thermopen glazing.

1. A blast-resistant window system for sealing an opening in a wall delimiting an interior space (IR), comprising:
a window arrangement sealing the opening, which arrangement comprises a window pane with an outside (AF) and an inside (IF) facing the interior space, and a holding device for the window pane, preferably in form of a window frame, for holding the window pane in the opening, with the window arrangement completely sealing the opening in a closed position, and
a protective window pane arrangement which covers the opening at least partly and is arranged between window arrangement and interior space (IR), comprising a protective pane preferably embedded in a window frame for the protective pane and a holding device for the protective pane for holding the protective window pane optionally with the window frame with the wall, with the holding device for the protective pane being configured in such a way that the protective window pane or the window frame with the protective window pane is held on or in front of the wall in such a way that they are or it is swivelable and/or laterally displaceable relative to the opening, characterized in that a non-sealable permanent airing cross section is present between the protective window pane arrangement and the wall.

2. A window system according to claim 1, wherein the holding device for the protective window pane is held on the wall or outside of the soffit.

3. A window system according to claim 1, wherein the holding device for the protective device comprises: at least two bands for pivotably holding the protective window pane with or without the window frame for the protective pane and a locking device, which is preferably attached to a side of the window frame opposite of the bands for detachably arresting the protective window pane optionally with the window frame relative to the wall.

4. A window system according to claim 1, wherein the holding device and especially the locking device are provided with a resilient configuration in the case of a blast-induced destruction of the window arrangement in particular and a force then acting upon the outside (AS) of the protective window pane averted from the interior space (IR) and the holding device above a predetermined force threshold in a direction transversally to the cross sectional surface of the opening into the interior space (IR).

5. A window system according to claim 4, wherein the locking device comprises a stop connected with the wall and a spring element which presses the protective window pane or optionally the window frame in a usually detachable manner under pre-tension against the stop (124-5) and which under the influence of a force above a force threshold allows a movement of the protective window pane optionally together with the window frame with a movement component transversally to the cross sectional surface of the opening into the interior space (IR).

6. A window system according to claim 4 further comprising a limiting device in the form of scissors or a wire cable loop, for limiting the movement of the protective window pane in particular into the interior space to a predetermined path length.

7. A window system according to claim 1, wherein the holding device for the protective window pane is configured in the form of a plurality of point-like connections which hold the protective window pane and optionally also the window frame at a predetermined distance from the wall or the soffit, so that, apart from the point-like connections, at least one air gap is formed between the protective window pane or the window frame and the wall.

8. A window system according to claim 1, wherein the distance between the window pane of the window arrangement and the protective window pane of the protective window pane arrangement is at least 10 cm, preferably at least 20 cm.

9. A window system according to claim 1, wherein the bands are elastically joined to the wall in such a way that their distance from the window arrangement can be increased against a counter-force in the event of a pressure effect.

10. A window system according to claim 1, wherein the window pane of the window arrangement and/or the protective window pane arrangement are configured as security windows so as to resist at least one of: break-ins, blasts and/or penetration by bullets.

11. A window system according to claim 1, wherein the window arrangement is arranged as a fixed field or casement window with casements or as a façade element.

12. A window system according to claim 2 wherein the holding device for the protective device comprises: at least two bands for pivotably holding the protective window pane with or without the window frame for the protective pane and a locking device which is preferably attached to a side of the window frame opposite of the bands for detachably arresting the protective window pane optionally with the window frame relative to the wall.

13. A window system according to claim 2, wherein the holding device and especially the locking device are provided with a resilient configuration in the case of a blast-induced destruction of the window arrangement in particular and a force then acting upon the outside (AS) of the protective window pane averted from the interior space (IR) and the holding device above a predetermined force threshold in a direction transversally to the cross sectional surface of the opening into the interior space (IR).

14. A window system according to claim 2, wherein the holding device for the protective window pane is configured in the form of a plurality of point-like connections which hold the protective window pane and optionally also the window frame at a predetermined distance from the wall or the soffit, so that, apart from the point-like connections, at least one air gap is formed between the protective window pane or the window frame and the wall.

15. A window system according to claim 2, wherein the distance between the window pane of the window arrangement and the protective window pane of the protective window pane arrangement is at least 10 cm, preferably at least 20 cm.

16. A window system according to claim 2, wherein the bands are elastically joined to the wall in such a way that their distance from the window arrangement can be increased against a counter-force in the event of a pressure effect.

17. A window system according to claim 2, wherein at least one of the window pane of the window arrangement, and the protective window pane arrangement are configured as security windows so as to resist break-ins, blasts and/or penetration by bullets.

18. A window system according to claim 2, wherein the window arrangement is arranged as a fixed field or casement window with casements or as a façade element.

19. A window system according to claim 5 further comprising a limiting device in the form of scissors or a wire cable loop, for limiting the movement of the protective window pane in particular into the interior space to a predetermined path length.

20. A window system according to claim 3, wherein the window arrangement is arranged as at least one of: a fixed field window, casement window, and a façade element.
